(19) United States
(12) Patent Application Publication
(10) Pub. No.: US 2025/0094724 A1
(43) Pub. Date: Mar. 20, 2025

(54) PROCESSING DEVICE, TRAINING DEVICE, PROCESSING SYSTEM, PROCESSING METHOD, AND STORAGE MEDIUM

(71) Applicant: KABUSHIKI KAISHA TOSHIBA, Tokyo (JP)

(72) Inventors: Xinyi ZHOU, Yokohama Kanagawa (JP); Fumiya YAMAMOTO, Chigasaki Kanagawa (JP); Takanori YOSHII, Kawasaki Kanagawa (JP); Yasuo NAMIOKA, Nerima Tokyo (JP); Takashi TANAKA, Asaka Saitama (JP); Kazuhiro OKA, Yokohama Kanagawa (JP); Takehiro KATO, Yokohama Kanagawa (JP); Keisuke NISHIMURA, Fujisawa Kanagawa (JP); Masahiro KOTAKE, Yokohama Kanagawa (JP)

(21) Appl. No.: 18/605,538

(22) Filed: Mar. 14, 2024

(30) Foreign Application Priority Data
Sep. 20, 2023 (JP) 2023-152491

(51) Int. Cl. G06F 40/35

(52) U.S. Cl. CPC G06F 40/35

(57) ABSTRACT

According to one embodiment, a processing device acquires an image, a coordinate, and dialog data communicated between a first device and a second device. The first device is used by a first person performing a task, and the second device is used by a second person. The processing device extracts at least one of a plurality of the coordinates based on the dialog data. The processing device associates the extracted at least one of the plurality of coordinates with the task.

### CROSS-REFERENCE TO RELATED APPLICATIONS

This application is based upon and claims the benefit of priority from Japanese Patent Application No. 2023-152491, filed on Sep. 20, 2023; the entire contents of which are incorporated herein by reference.

### FIELD

Embodiments described herein relate generally to a processing device, a training device, a processing system, a processing method, and a storage medium.

### BACKGROUND

A task may be performed while one person instructs another person. To save manpower or conserve energy when instructing, it is favorable to automate at least a part of the instruction. To automate the instruction, it is necessary to accumulate data that can be utilized for training.

### BRIEF DESCRIPTION OF THE DRAWINGS

FIG. 1 is a schematic view showing a processing system according to an embodiment;

FIG. 2 is a schematic view illustrating a head mounted display;

FIG. 3 is a schematic view illustrating another head mounted display;

FIG. 4 is a flowchart showing processing by the processing system according to the embodiment;

FIG. 5 is a schematic view showing a dialog example of a task;

FIG. 6 is a schematic view showing the dialog example of the task;

FIG. 7 is a schematic view showing the dialog example of the task;

FIG. 8 is a flowchart showing a specific example of a scenario;

FIG. 9 is a table illustrating the extracted data;

FIG. 10 is a flowchart showing a specific example of the processing by the processing device according to the embodiment;

FIG. 11 is a table illustrating training data;

FIG. 12 is a flowchart showing processing by the training device according to the embodiment;

FIGS. 13A to 13C show stored training data;

FIG. 14 is a flowchart showing processing by the processing device according to the embodiment;

FIG. 15 is a schematic view showing a dialog example of another task;

FIG. 16 is a schematic view showing the dialog example of another task;

FIG. 17 is a schematic view showing the dialog example of another task;

FIG. 18 is a flowchart showing a specific example of a scenario;

FIG. 19 is a table illustrating extracted data;

FIG. 20 is a flowchart showing a specific example of processing by the processing device according to the embodiment.

FIGS. 21A to 21D are examples of training data;

FIG. 22 is a flowchart showing processing by the training device according to the embodiment;

FIG. 23 is a flowchart showing processing by the processing device according to the embodiment;

FIG. 24 is a schematic view illustrating a pointing part according to the embodiment;

FIGS. 25A to 25D are schematic views illustrating the pointing part according to the embodiment; and

FIG. 26 is a schematic view illustrating a hardware configuration.

### DETAILED DESCRIPTION

According to one embodiment, a processing device acquires an image, a coordinate, and dialog data communicated between a first device and a second device. The first device is used by a first person performing a task, and the second device is used by a second person. The processing device extracts at least one of a plurality of the coordinates based on the dialog data. The processing device associates the extracted at least one of the plurality of coordinates with the task.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

When a novice performs a task with little knowledge or experience, it is desirable for an expert to instruct the novice. However, the decline in the number of experts, economic globalization, infectious disease epidemics, etc., may make it difficult for people to gather in the same location. In such a case, virtual reality (VR) technology, mixed reality (MR) technology, and the like using head mounted displays (HMDs) are useful. VR technology or MR technology enables other persons to share the visual field of one person. The application of VR technology or MR technology enables smooth communication even between persons distant to each other. An expert can instruct a novice more efficiently and more clearly.

Meanwhile, to save manpower or conserve energy when performing a task, it is favorable to automate at least a part of the instruction to the novice. To automate the instruction, it is necessary to accumulate much data that can be utilized for training. Inventions according to embodiments can be utilized for the automatic acquisition of data.

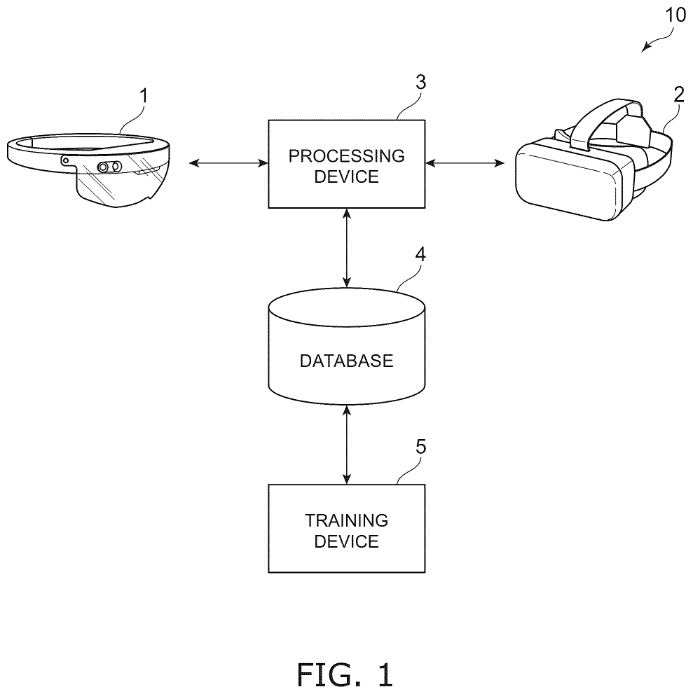

FIG. 1 is a schematic view showing a processing system according to an embodiment.

As shown in FIG. 1, the processing system 10 according to the embodiment includes a first device 1, a second device 2, a processing device 3, a storage device 4, and a training device 5.

In the illustrated example, the first device 1 and the second device 2 are HMDs. The HMD includes a display device, imaging devices, an input device (a microphone), sensors, a processing circuit, etc. The first device 1 and the second device 2 communicate data via the processing device 3.

The processing device 3 stores data received from the first and second devices 1 and 2 in the storage device 4. The processing device 3 uses the data stored in the storage device 4 to generate data for training. The training device 5 trains using the generated data. The first device 1, the second device 2, the processing device 3, the storage device 4, and the training device 5 are connected to each other via wireless communication or a network.

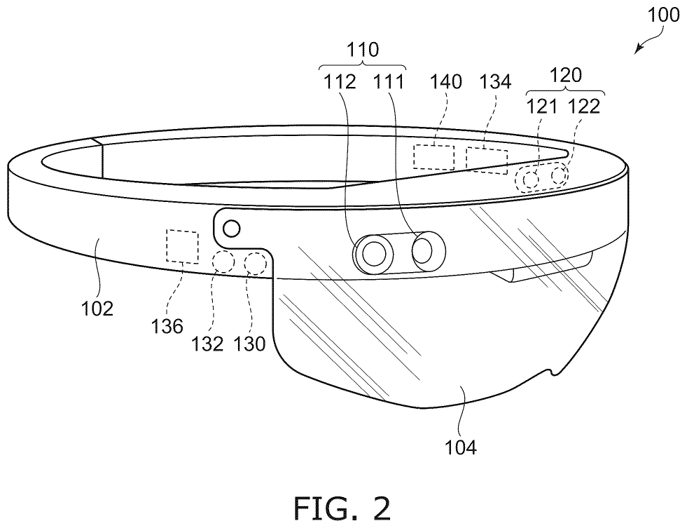

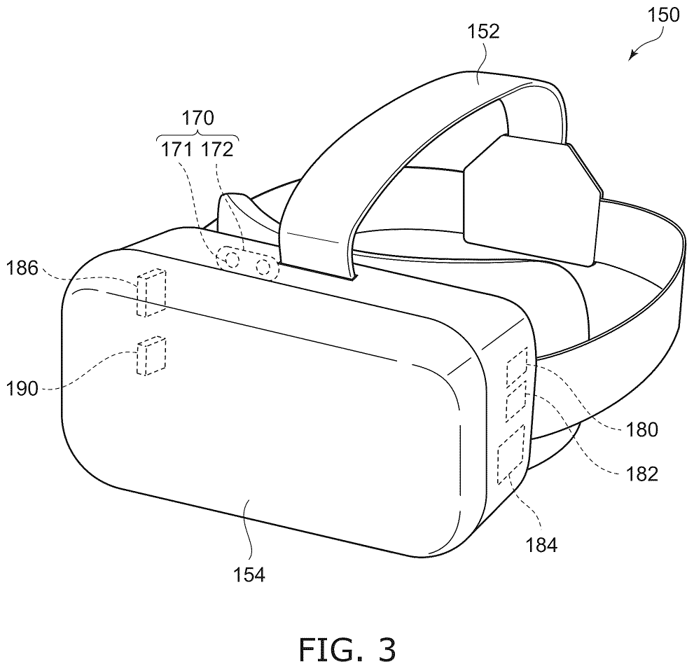

FIGS. 2 and 3 are schematic views illustrating head mounted displays.

A HMD 100 shown in FIG. 2 can be used as the first device 1. The first device 1 is, for example, a MR device. The HMD 100 includes a band 102, a display 104, an imaging device 110, an imaging device 120, a microphone 130, a speaker 132, a battery 134, a sensor 136, and a control device 140.

The HMD 100 is mounted to the head of a person. The band 102 is flexible, and is attached to and detached from the head of the person. The display 104 is mounted to the band 102, and displays information. The display 104 is optically transmissive; and a projection device (not illustrated) may project information toward the display 104.

The imaging device 110 images the scene in front of the display 104. For example, the imaging device 110 includes an image camera 111 and a depth camera 112. The image camera 111 acquires a two-dimensional RGB image based on visible light reflected from objects. The depth camera 112 irradiates infrared light on an object, and acquires an image of the depth (frontward distance) based on the infrared light reflected from the object.

The imaging device 120 images an eye of a person. For example, the imaging device 120 includes an image camera 121 and a depth camera 122. The image camera 111 acquires an RGB image of the eye. The depth camera 112 acquires a depth image of the eye. The voice of the person is input to the microphone 130. The speaker 132 outputs sound toward the person. The battery 134 supplies power to the components of the HMD 100. The sensor 136 is a six-axis detection sensor, and is configured to detect an angular velocity in three axes and an acceleration in three axes.

The control device 140 controls the components of the HMD 100. For example, the control device 140 controls the content output to the display 104 and the speaker 132. The control device 140 detects movement of the visual field based on the detection result of the sensor 136. The control device 140 calculates the position of the eye of the person, the orientation of the line of sight, etc., based on data obtained by the image camera 121 and the depth camera 122. The image camera 121 and the depth camera 122 track the line of sight of the person by repeatedly acquiring the data, and repeatedly processing the data. In other words, eye tracking is performed. The control device 140 adjusts the display position of information in the display 104 according to the calculated line of sight. The control device 140 controls the focal point of the image camera 111 according to the calculated line of sight.

The HMD 150 shown in FIG. 3 can be used as the second device 2. The second device 2 is, for example, a VR device. The HMD 150 includes a band 152, a display 154, an imaging device 170, a microphone 180, a speaker 182, a battery 184, a sensor 186, and a control device 190.

The HMD 150 is mounted to the head of a person. The band 152 is flexible, and is attached to and detached from to the head of the person. The display 154 is mounted to the band 152, and displays information. The display 154 is optically non-transmissive. A projection device (not illustrated) may project information toward the display 154.

The imaging device 170 images an eye of a person. For example, the imaging device 170 includes an image camera 171 and a depth camera 172. The image camera 171 acquires an RGB image of the eye. The depth camera 172 acquires a depth image of the eye. The voice of the person is input to the microphone 180. The speaker 182 outputs sound toward the person. The battery 184 supplies power to the components of the HMD 150. The sensor 186 is a six-axis detection sensor.

The control device 190 controls the components of the HMD 150. For example, the control device 190 controls the content output to the display 154 and the speaker 182. The control device 190 detects movement of the visual field based on the detection result of the sensor 186. The control device 190 performs eye tracking by calculating the position of the eye of the person, the orientation of the line of sight, etc., based on data obtained by the image camera 171 and the depth camera 172. The control device 190 adjusts the display position of information in the display 154 according to the calculated line of sight.

The configuration of the HMD is not limited to the illustrated example, and is arbitrary. The configuration of the HMD is arbitrarily selected from monocular goggles, binocular eyeglasses, headwear, a helmet completely covering the head, etc. It is favorable for the novice actually performing the task to wear a MR device so that the real scene can be seen. It is favorable for the expert to wear a VR device to be more immersed in the environment of the novice.

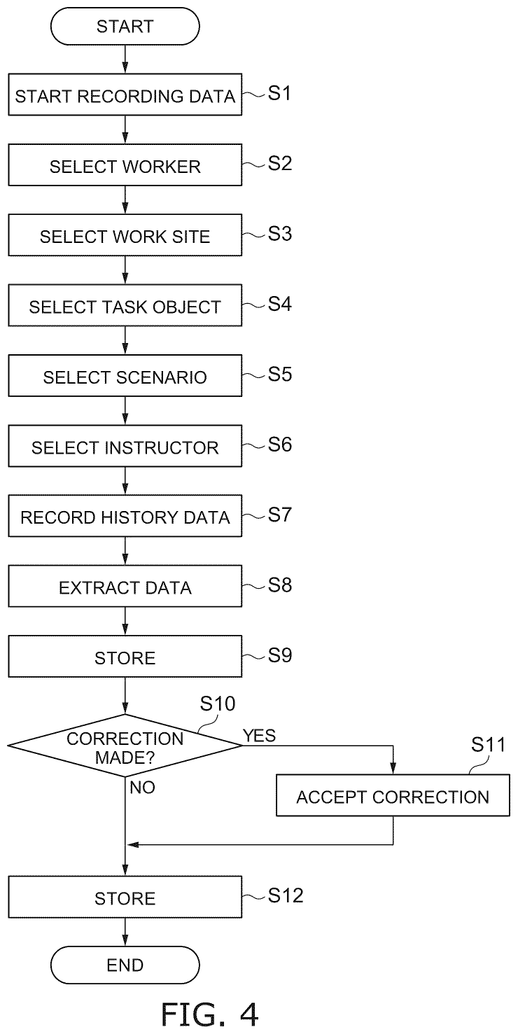

FIG. 4 is a flowchart showing processing by the processing system according to the embodiment.

First, data recording is started (step S1). For example, images and dialog data acquired by the imaging devices of the HMDs, data acquired by devices used in the task, etc., are recorded. When sensors and the like that monitor the task are included, recording of the sensor data also is started. The data is repeatedly stored in the storage device 4.

The processing device 3 accepts a selection of a worker (step S2). The worker is the person that actually performs the task. The processing device 3 accepts a selection of a work site (step S3). The processing device 3 accepts a selection of a task object (step S4). The processing device 3 accepts a selection of a scenario (step S5). The scenario is a file in which procedures of the processing by the processing device 3 are defined. For example, data (a voice) that indicates the worker, work site, task object, and scenario is input to the microphone of the HMD worn by the worker. The processing device 3 selects the worker, work site, task object, and scenario based on the input data. The worker, work site, task object, and scenario may be automatically selected based on a work schedule, etc.

The processing device 3 accepts a selection of an instructor (step S6). The instructor is a person that instructs the worker. The worker (a first person) and the instructor (a second person) each wear HMDs (the first device and the second device). For example, data that indicates the instructor is input to the microphone of the HMD worn by the instructor. The processing device 3 selects the instructor based on the input data. Instructors may be pre-assigned to workers, work sites, task objects, or scenarios; and the instructor may be automatically selected according to the selected worker, work site, task object, or scenario.

When the selections of steps S2 to S6 are completed, the worker starts the task. Various data is repeatedly acquired in the task. The processing device 3 stores the acquired data as history data in the storage device 4 (step S7). The processing device 3 extracts a part of the data from the stored history data (step S8). Hereinafter, the data that is extracted from the history data by the processing device 3 is called “extracted data”.

For example, a specific operation by the worker and instructor is extracted. The operation is the act of pointing to a point (a coordinate) in an image, an identification result of the image, etc. Herein, “coordinate” means one or more numerical values specifying a position in one or more spatial dimensions. The extracted data is used as annotation. The annotation indicates a region of the task object to be given attention, information related to the region, etc. The processing device 3 stores the extracted data in the storage device 4 (step S9).

The processing device 3 may output the extracted data toward a user, and may accept a correction from the user. The user is a manager of the processing system 10, an instructor, a worker, etc. For example, the processing device 3 determines whether or not there is a correction of the extracted data (step S10). When there is a correction, the processing device 3 accepts the correction (step S11). Instead of a correction, the extracted data may be deleted. For example, the selection of an inappropriate coordinate by the worker may be corrected to an appropriate coordinate, or may be deleted. When there is no correction in step S10 or when a correction is accepted in step S11, the processing device 3 stores the extracted data in the storage device 4 (step S12).

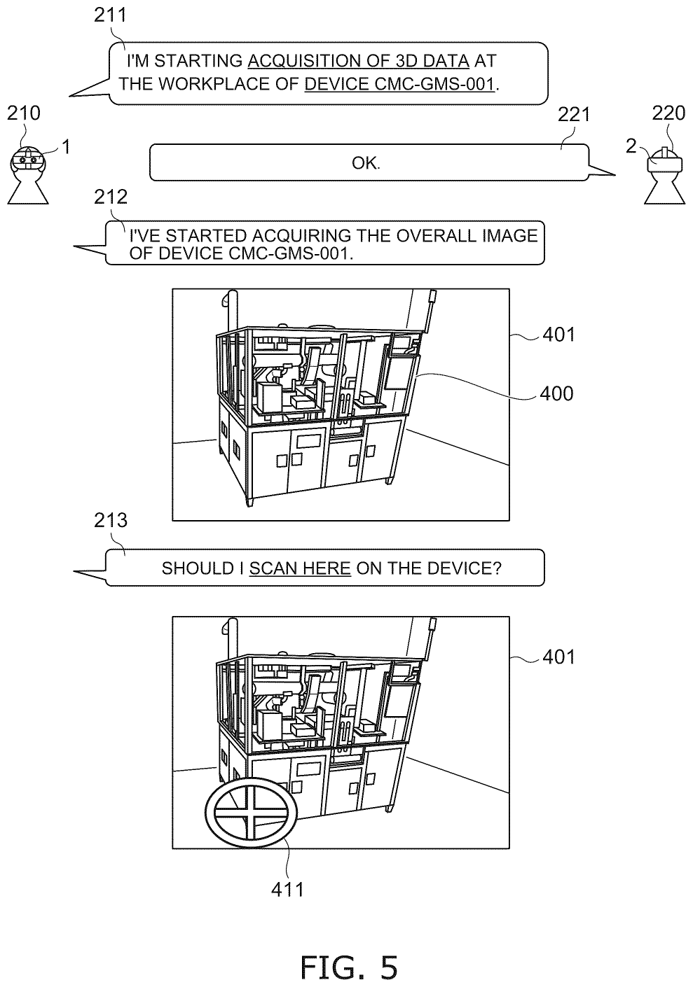

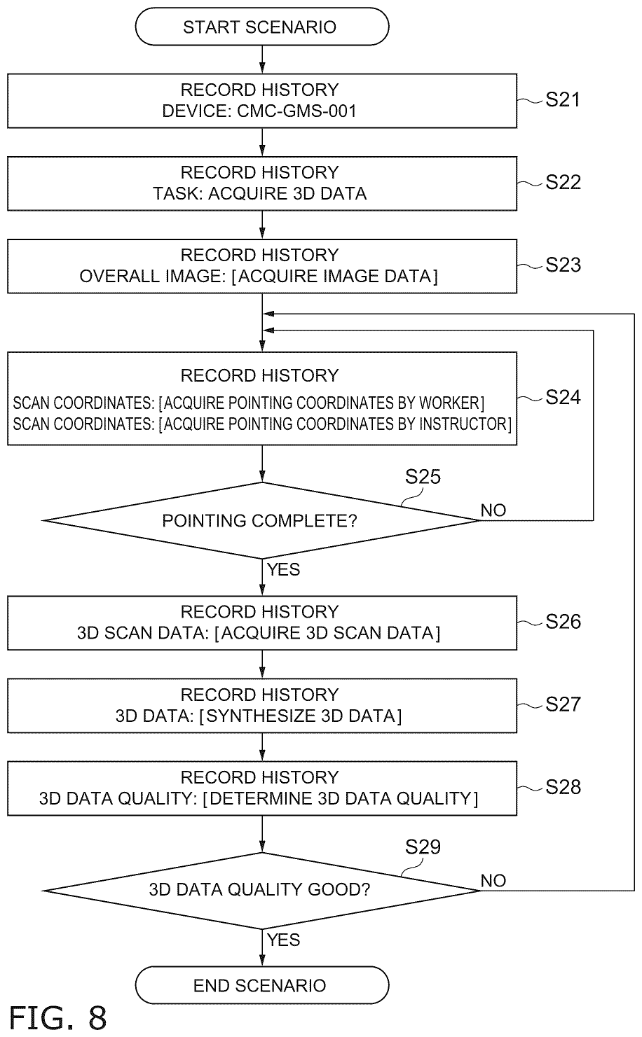

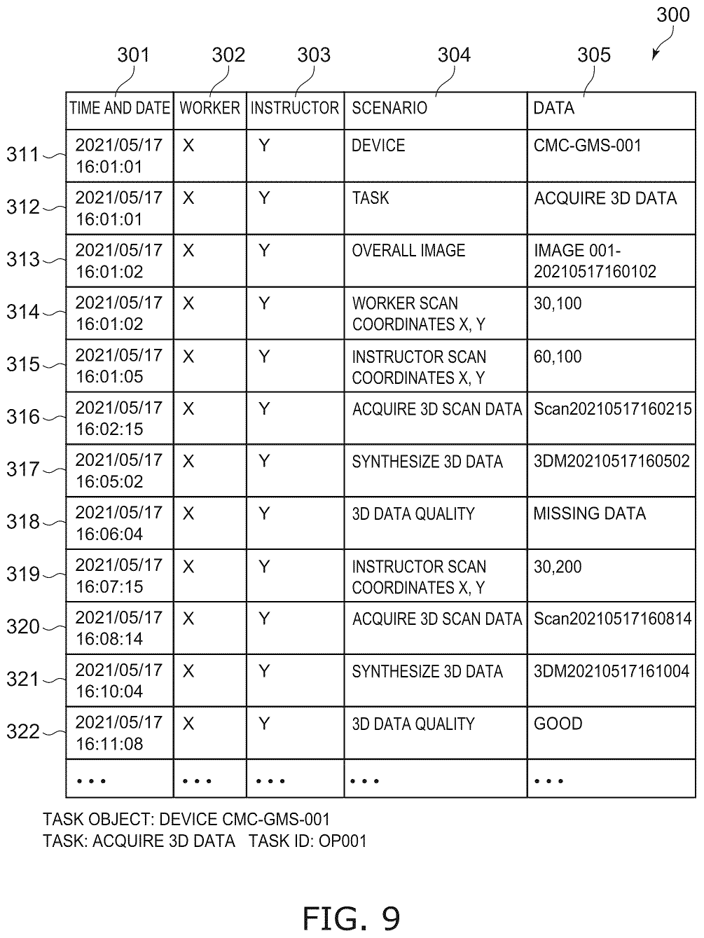

FIGS. 5 to 7 are schematic views showing a dialog example of a task. FIG. 8 is a flowchart showing a specific example of a scenario. FIG. 9 is a table illustrating the extracted data.

An embodiment will now be described with reference to a specific example. FIGS. 5 to 7 show a dialog example when acquiring 3D data. A worker 210 and an instructor 220 converse using the first device 1 and the second device 2. The dialog is performed using the microphones of the HMDs. The dialog may be performed using input devices such as keyboards, etc. In the illustrated dialog example, utterances 211 to 215 of the worker 210 are transmitted from the first device 1 to the second device 2. Utterances 221 to 227 of the instructor 220 are transmitted from the second device 2 to the first device 1. The contents of the utterances 211 to 215 and 221 to 227 are stored as text data in the storage device 4.

The processing device 3 performs intention understanding for the utterances. Publicly known technology is applicable to the intention understanding. In summary, the processing device 3 performs morphological analysis, syntactic analysis, and semantic analysis. In morphological analysis, a sentence is segmented into morphemes which are the minimum units. Syntactic analysis recognizes the parts of speech of the segmented morphemes. Syntactic analysis also analyzes the sentence structure such as clause syntax and the like based on grammar rules, etc. In semantic analysis, semantic syntax that represents the meaning conveyed by a sentence is synthesized based on the word meaning (the concept) of the words in the sentence, semantic relationships between words, etc. In the dialog example, parts particularly relevant to data extraction are underlined.

The utterance 211 includes the device “CMC-GMS-001” indicating the task object, and “acquisition of 3D data” indicating the task content. The processing device 3 selects the task object and the task content from the intention understanding of the utterance 211. The processing device 3 also refers to a prescribed database, acquires data of the workplace in which the task object is installed, and determines the work site.

The processing device 3 selects, from multiple scenarios stored in the storage device 4, the scenario of “acquisition of 3D data” corresponding to the selected task object and task content. The scenario defines the type of data to be recorded as history data, the order of the data recording, etc. The scenario of “acquisition of 3D data” is an example of a first scenario.

As shown in FIG. 8, the processing device 3 records the task object and the task content in the storage device 4 based on the utterance 211 (steps S21 and S22). As shown in FIG. 9, a time and date 301, a worker 302, an instructor 303, a scenario 304, and data 305 are recorded in a database 300 in which the data of the task object, task name, and task ID are associated. The scenario 304 is the name of the processing included in the selected scenario. The data 305 is the name or data value of the data obtained in the processing of the scenario 304. For example, steps S21 and S22 record data in a row 311 and a row 312 of the database 300.

Then, the imaging device of the HMD of the worker 210 acquires an image. The processing device 3 records the acquired image in the storage device 4 (step S23). The image may be acquired by the imaging device before determining the scenario; and the recording of the image may be started based on the result of the intention understanding of the utterance 212. The acquired data (image) is recorded in a row 313 of the database 300. The acquired image also is transmitted to the HMD of the instructor 220. The instructor 220 can share the visual field of the worker 210 by means of the image visible in the display of the HMD.

An image 401 shown in FIG. 5 shows a part of the acquired image. A device 400 is visible in the image 401. In the task of “acquisition of 3D data”, the worker uses a 3D scanner to scan the device 400. Point cloud data is obtained by the scan. The point cloud data is used to synthesize 3D data.

For example, many coordinates are pointed to by eye tracking or other pointing tools of the first and second devices 1 and 2. Among such coordinates, the worker 210 points to a coordinate 411 in a part of the image 401. The worker 210 also asks the instructor 220, with the utterance 213, whether or not the coordinate 411 is appropriate. The processing device 3 uses the intention understanding of the utterance 213 to determine that the coordinate 411 is a scan coordinate. As shown in FIGS. 8 and 9, the processing device 3 records, in a row 314 of the database 300, the coordinate being pointed to (step S24).

The instructor 220 conveys by the utterance 222 that the coordinate 411 being pointed to is appropriate. The instructor 220 also points to a coordinate 412 in a part of an image 402 to convey by the utterance 222 to the worker 210 that the coordinate 412 should be scanned. The processing device 3 uses the intention understanding of the utterance 222 to determine that the coordinate 412 is a scan coordinate. As shown in FIG. 9, the processing device 3 records, in a row 315 of the database 300, the coordinate 412 being pointed to. Similarly to the coordinates 411 and 412, the recording of coordinates in the subsequent processing also is based on the intention understanding of the utterances by the processing device 3.

The processing device 3 determines whether or not the pointing is complete (step S25). The device 400 is scanned at multiple coordinates in the “acquisition of 3D data”. For example, when all of the coordinates to be scanned have been pointed to, the worker or the instructor provides an input to the processing device 3 that the pointing of all of the coordinates is complete.

The worker 210 scans the device 400 at the coordinates 411 and 412. As shown in FIGS. 8 and 9, the processing device 3 records the scanned data in a row 316 of the database 300 (step S26). The worker 210 conveys by the utterance 214 to the instructor 220 that the scan is complete.

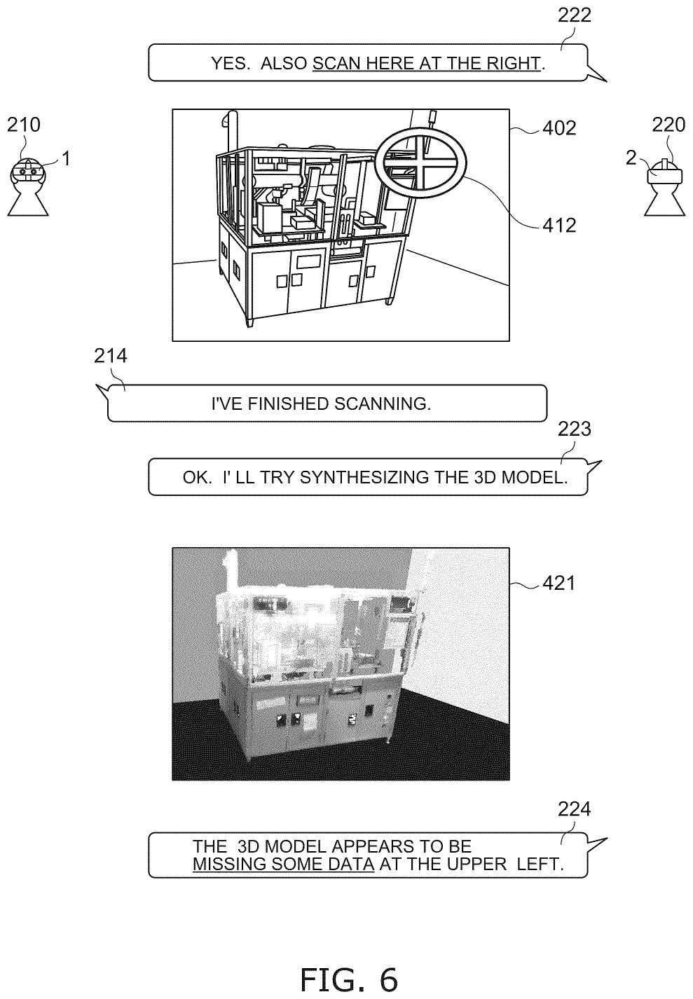

The instructor 220 conveys by the utterance 223 to the worker 210 that 3D data will be synthesized based on the scanned data. 3D data 421 shown in FIG. 6 is 3D data of the device 400 based on the scanned data. As shown in FIGS. 8 and 9, the processing device 3 records the synthesized 3D data in a row 317 of the database 300 (step S27).

The instructor 220 checks the 3D data 421. The instructor 220 conveys by the utterance 224 to the worker 210 that the quality of the synthesized 3D data is not good. As shown in FIGS. 8 and 9, based on the intention understanding, the processing device 3 records the quality of the synthesized 3D data in a row 318 of the database 300 (step S28).

The processing device 3 determines whether or not 3D data having good quality is obtained (step S29). Step S24 is re-performed when the quality of the 3D data is not good. For example, based on the intention understanding of the utterance 224 of the instructor 220, the processing device 3 determines that the quality of the 3D data is not good.

The instructor 220 points to a coordinate 413 in a part of an image 403 and conveys by the utterance 225 to the worker 210 that the coordinate 413 should be scanned. The processing device 3 records, in a row 319 of the database 300, the coordinate that is pointed to.

The worker 210 scans the device 400 at the coordinate 413 being pointed to. The processing device 3 records the scanned data in a row 320 of the database 300. The worker 210 conveys by the utterance 215 to the instructor 220 that the scan is complete.

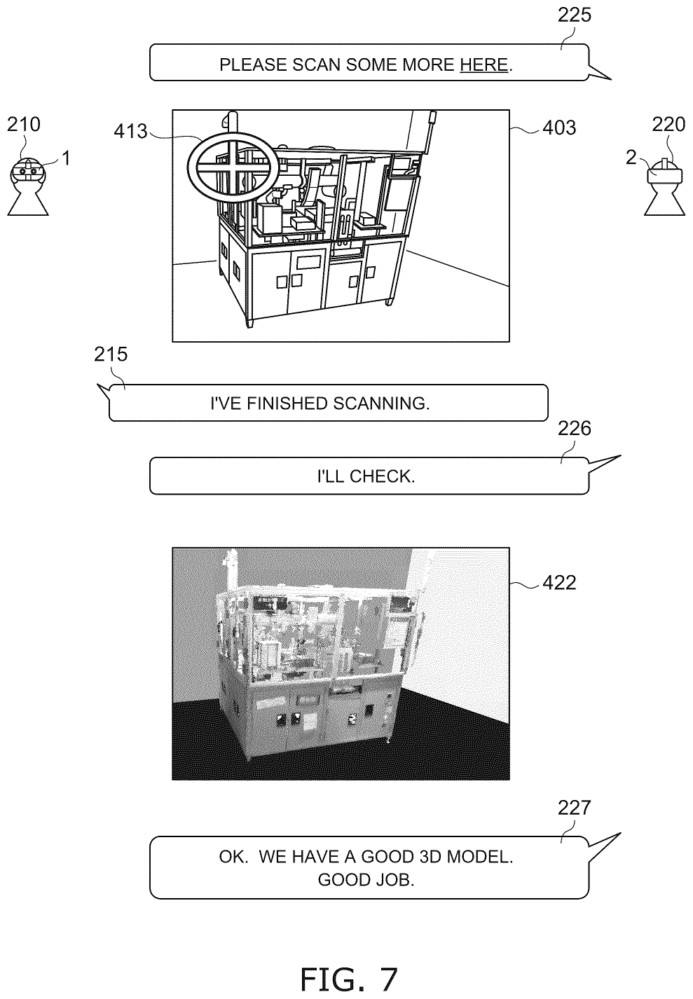

The instructor 220 conveys the intention of re-synthesizing the 3D data by the utterance 226 to the worker 210. 3D data 422 shown in FIG. 7 is 3D data of the device 400 that is synthesized using the newly scanned data. The processing device 3 records the synthesized 3D data in a row 321 of the database 300.

The instructor 220 checks the 3D data 422. The instructor 220 conveys by the utterance 227 to the worker 210 that the quality of the synthesized 3D data is good. Based on the intention understanding, the processing device 3 records the quality of the synthesized 3D data in a row 322 of the database 300. Because good 3D data is obtained, the processing device 3 ends the scenario of “acquisition of 3D data”.

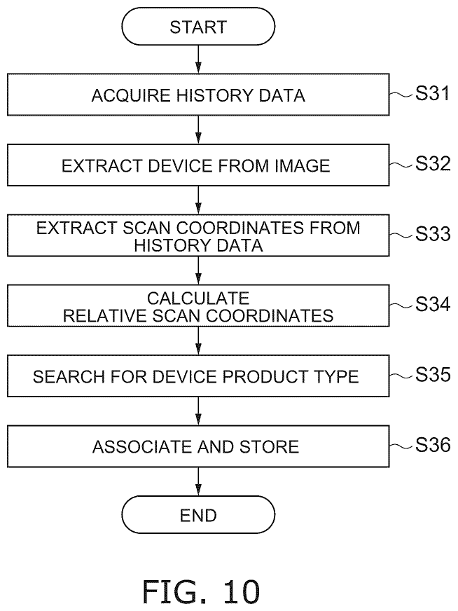

FIG. 10 is a flowchart showing a specific example of the processing by the processing device according to the embodiment.

The processing device 3 uses a part of the history data stored in the database 300 to generate training data. Specifically, as shown in FIG. 10, the processing device 3 acquires history data (step S31). Based on an image included in the history data, the processing device 3 extracts the device that is the task object (step S32). For example, the processing device 3 extracts the device based on a part of the images obtained by the imaging device of the HMD in the task. The processing device 3 calculates the coordinate of the extracted device.

The processing device 3 extracts scan coordinates from the history data (step S33). The processing device 3 calculates the scan coordinates relative to the device coordinate (step S34). The processing device 3 searches for the product type of the device “CMC-GMS-001” which is the task object (step S35). The processing device 3 associates the relative scan coordinates with the product type, and stores the results as training data in the storage device 4 (step S36). Although the training data is associated with the product type of the device in the example, the training data may be directly associated with the device.

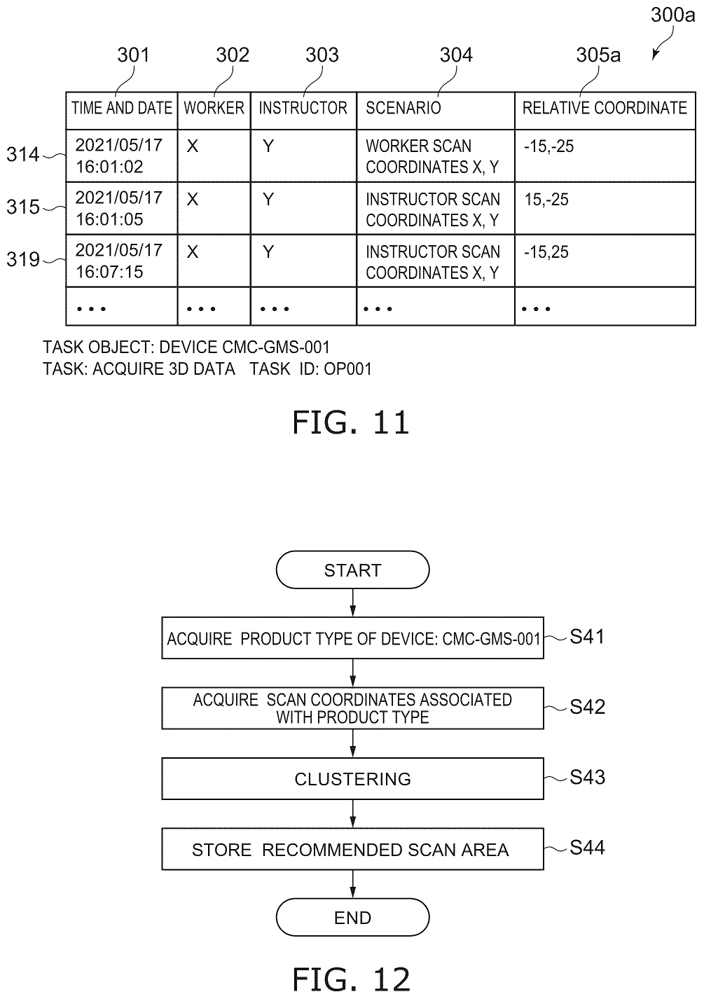

FIG. 11 is a table illustrating training data.

The training data 300a shown in FIG. 11 includes the rows 314, 315, and 319 related to the scan coordinates extracted from the database 300. Scan coordinates relative to the device coordinate are recorded in a column 305a. The relative coordinates are used as training data.

FIG. 12 is a flowchart showing processing by the training device according to the embodiment.

The training device 5 performs training by using the training data generated by the processing device 3. As shown in FIG. 12, the training device 5 acquires the product type of the device “CMC-GMS-001” (step S41). The training device 5 acquires multiple relative scan coordinates associated with the product type from the training data stored by the processing device 3 (step S42). The training device 5 performs clustering of the multiple scan coordinates (step S43). The clustering is performed by unsupervised machine learning. As a result of the clustering, the multiple scan coordinates are classified into multiple groups. In each group, the set of scan coordinates represents the recommended area of the scan. The training device 5 stores the recommended scan area obtained by the clustering (step S44).

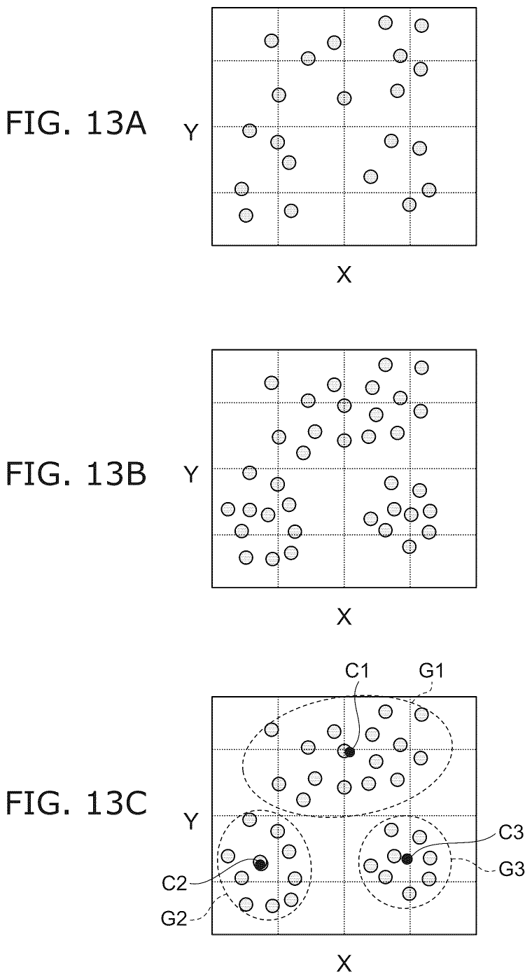

FIGS. 13A to 13C are schematic views illustrating training data.

FIGS. 13A to 13C show stored training data. In FIGS. 13A to 13C, the horizontal axis is the relative X-coordinate. The vertical axis is the relative Y-coordinate. FIG. 13A shows multiple scan coordinates accumulated by performing the task multiple times. FIG. 13B shows more scan coordinates accumulated by performing the task more times than FIG. 13A. As shown in FIGS. 13A and 13B, the training data is accumulated by repeating the task. The training device 5 clusters the multiple scan coordinates shown in FIG. 13B. As a result, for example, the multiple scan coordinates are classified into groups G1 to G3 as shown in FIG. 13C. The groups G1 to G3 are recommended scan areas.

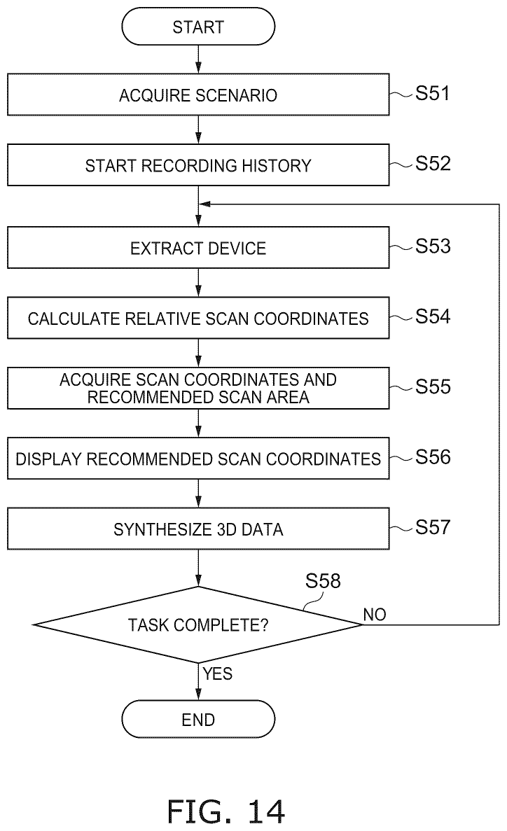

FIG. 14 is a flowchart showing processing by the processing device according to the embodiment.

After completing the training by the training device 5, the processing device 3 can instruct or support the task by using the trained data. After completing the training, the processing device 3 can be selected instead of the instructor in step S6 of the flowchart shown in FIG. 4.

When instruction by the processing device 3 is selected, the processing device 3 acquires a scenario corresponding to the device of the task object and the task content as shown in FIG. 14 (step S51). The processing device 3 starts to record the task history (step S52). The processing device 3 extracts the device based on the image (step S53). When the scan is performed by the worker, the processing device 3 calculates relative coordinates of the scan with respect to the device (step S54). The processing device 3 acquires the scan coordinates stored as the training data, and the recommended scan areas trained by the training device 5 (step S55).

The processing device 3 calculates a centroid of the multiple scan coordinates in each recommended scan area. For example, as shown in FIG. 13C, centroids C1 to C3 are calculated respectively for the groups G1 to G3. The processing device 3 displays the centroids of the recommended scan areas as recommended scan coordinates in the display of the HMD of the worker (step S56). The worker scans the recommended scan coordinates according to the guidance of the processing device 3.

The processing device 3 synthesizes 3D data when the recommended scan areas are scanned (step S57). The processing device 3 determines whether or not the task is complete (step S58). For example, the processing device 3 determines that the task is complete when 3D data having a good quality is synthesized.

The history data shown in FIG. 9 is obtained even during the instruction by the processing device 3. Data for training may be extracted from the obtained history data. The processing device 3 generates training data by using the extracted data. The training device 5 uses the generated training data to perform training.

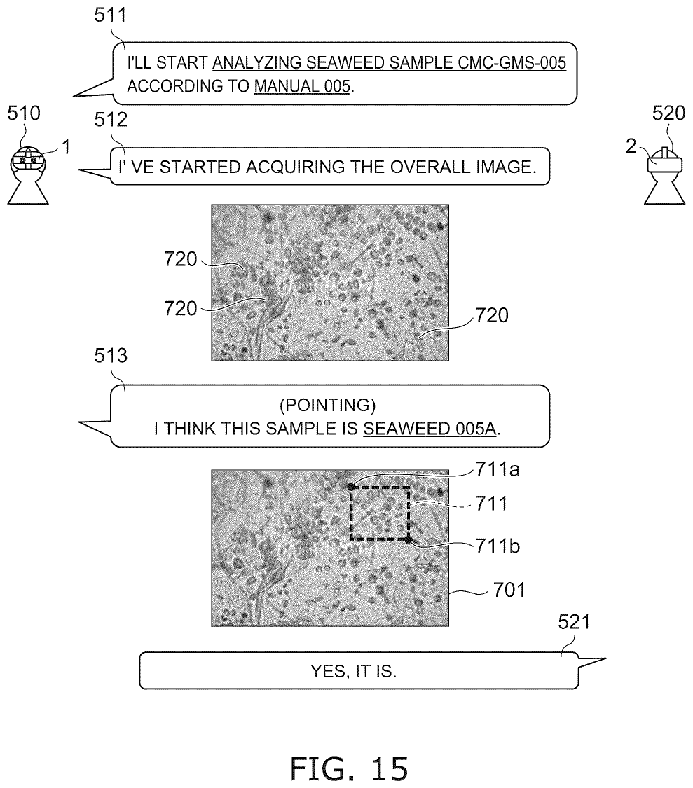

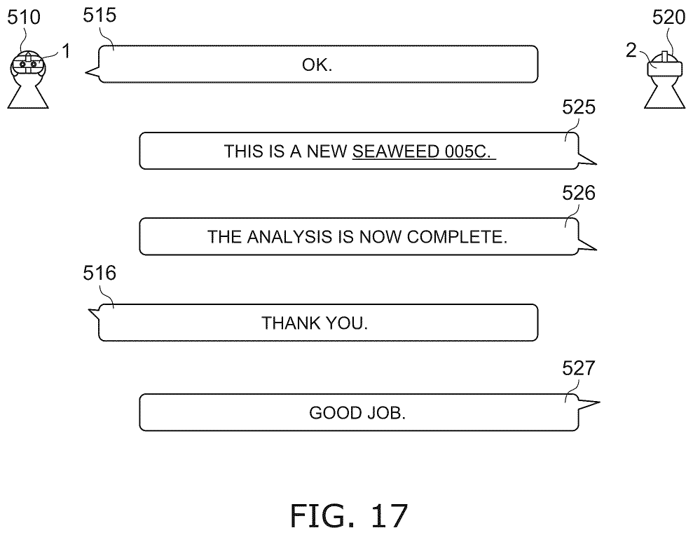

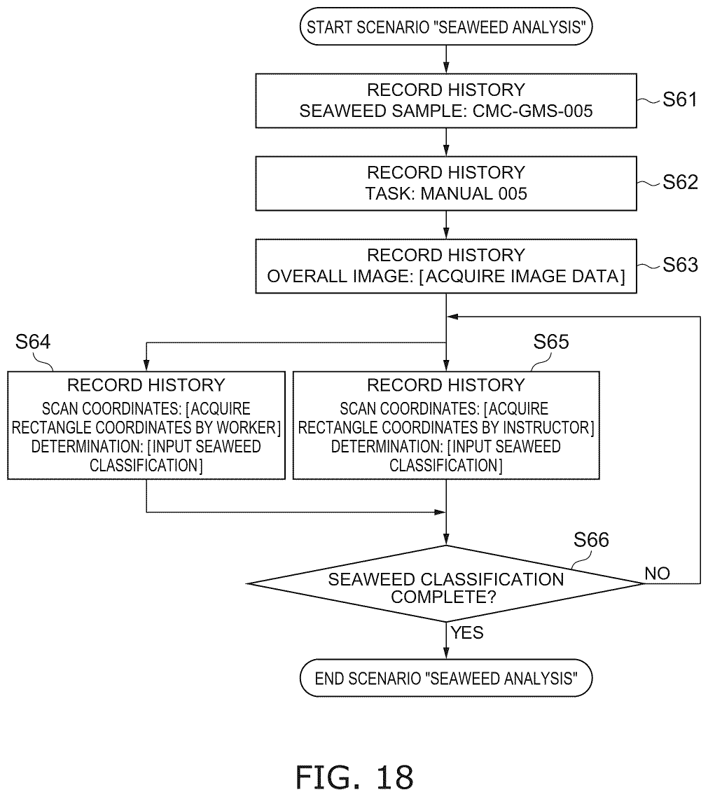

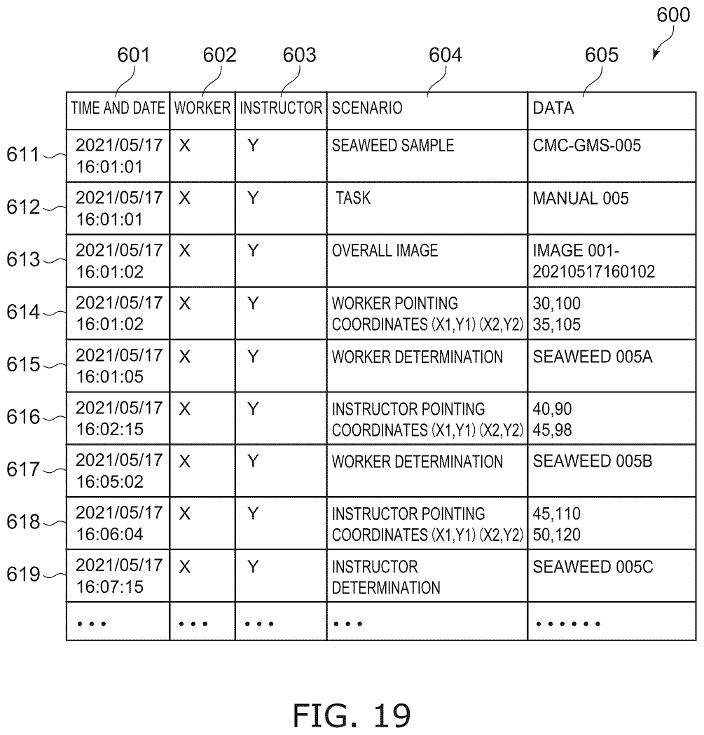

FIGS. 15 to 17 are schematic views showing a dialog example of another task. FIG. 18 is a flowchart showing a specific example of a scenario. FIG. 19 is a table illustrating extracted data.

FIGS. 15 to 17 show a dialog example when analyzing seaweed visible in an image. A worker 510 and an instructor 520 converse respectively by using the first device 1 and the second device 2. In the illustrated dialog example, utterances 511 to 516 of the worker 510 are transmitted from the first device 1 to the second device 2. Utterances 521 to 527 of the instructor 220 are transmitted from the second device 2 to the first device 1. The contents of the utterances 511 to 516 and 521 to 527 are stored as text data in the storage device 4.

The utterance 511 includes “seaweed sample CMC-GMS-005” indicating the task object, and “manual 005” indicating the task content. The processing device 3 selects the task object and the task content based on the intention understanding of the utterance 511. The processing device 3 also selects, from among the multiple scenarios stored in the storage device 4, the scenario of “seaweed analysis” corresponding to the selected task object and task content. The scenario of “seaweed analysis” is another example of the first scenario.

As shown in FIG. 18, based on the utterance 511, the processing device 3 records the task object and the task content (the scenario) in the storage device 4 (steps S61 and S62). As shown in FIG. 19, a time and date 601, a worker 602, an instructor 603, a scenario 604, and the data 605 are recorded in a database 600 in which the data of the task object, task name, and task ID are associated. The scenario 604 is the name of the processing included in the selected scenario. The data 605 is the name or data value of the data obtained in the processing of the scenario 604. For example, data is recorded in a row 611 and a row 612 of the database 600 by steps S61 and S62.

Then, an image is acquired by the imaging device of the HMD of the worker 510. The processing device 3 records the acquired image in the storage device 4 (step S63). The acquired data (image) is recorded in a row 613 of the database 600. The instructor 520 shares the visual field of the worker 510 by means of the image visible in the display of the HMD.

An image 701 shown in FIG. 15 shows a part of the acquired image. Multiple pieces of seaweed 720 are visible in the image 701. In the analysis of the seaweed sample, the worker images the seaweed and classifies the seaweed. The worker 510 points to coordinates 711a and 711b in a part of the image 701. A rectangle 711 is designated by pointing to the coordinates 711a and 711b.

As shown in FIGS. 18 and 19, the processing device 3 records the coordinates pointed to by the worker 510 in a row 614 of the database 600 (step S64). In the utterance 513, the worker 510 indicates that the coordinates 711a and 711b are pointed to, and describes the classification of the seaweed included in the rectangle 711. The processing device 3 records the classification of the seaweed described by the worker 510 in a row 615 of the database 600 (step S64). The instructor 520 conveys by the utterance 521 that the coordinates 711a and 711b are appropriate.

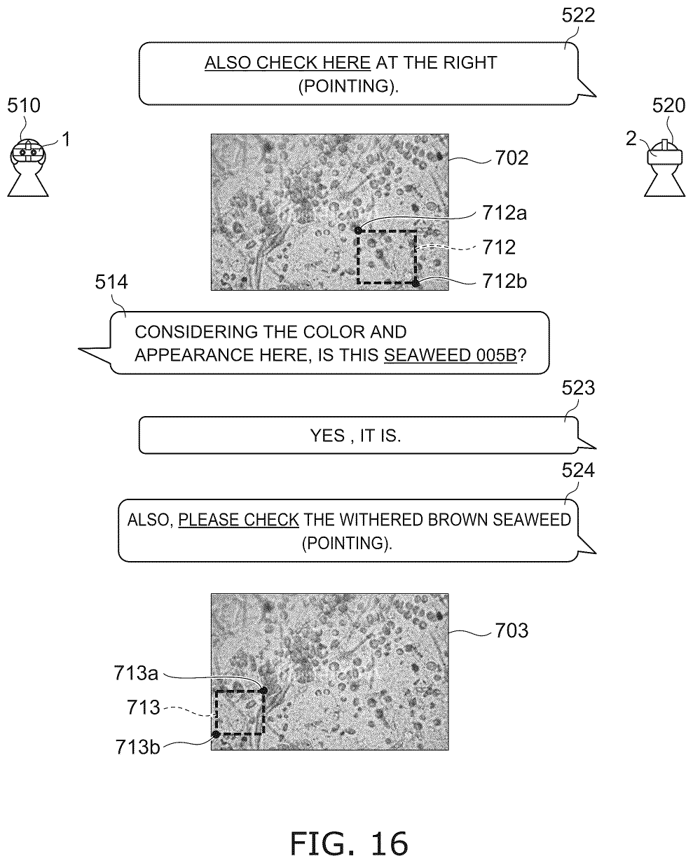

As shown in FIG. 16, the instructor 520 points to coordinates 712a and 712b in a part of an image 702. The instructor 520 conveys by the utterance 522 to the worker 510 that the seaweed included in a rectangle 712 designated by the coordinates 712a and 712b should be checked. The processing device 3 records, in a row 616 of the database 600, the coordinates 712a and 712b being pointed to (step S65).

In the utterance 513, the worker 510 describes the classification of the seaweed included in the rectangle 712 pointed to by the instructor 520. The processing device 3 records the classification of the seaweed described by the worker 510 in a row 617 of the database 600 (step S65). In the utterance 523, the instructor 520 affirms the classification described by the worker 510.

The instructor 520 conveys by the utterance 524 to the worker 510 that the seaweed included in a rectangle 713 designated by coordinates 713a and 713b in an image 703 should be checked. The processing device 3 records, in a row 618 of the database 600, the coordinates 713a and 713b being pointed to (step S65). In the utterance 525, the instructor 520 describes the classification of the seaweed included in the rectangle 713. The processing device 3 records the classification of the seaweed described by the instructor 520 in a row 619 of the database 600 (step S65).

The instructor 520 conveys by the utterance 526 to the worker 510 that the task is complete. The processing device 3 determines that the task of seaweed classification is complete in step S66, and ends the scenario.

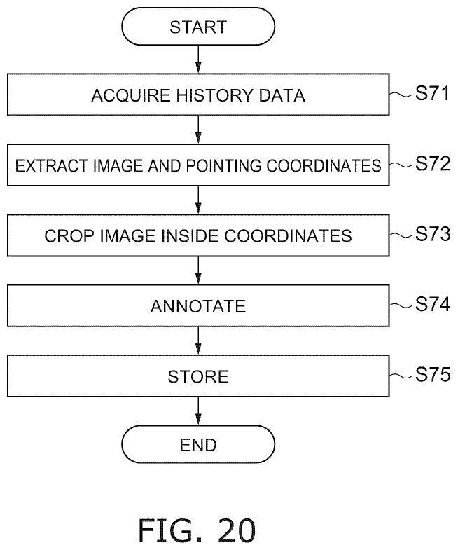

FIG. 20 is a flowchart showing a specific example of processing by the processing device according to the embodiment.

As shown in FIG. 20, the processing device 3 acquires history data (step S71). The processing device 3 extracts, from the history data, an image and coordinates that were pointed to (step S72). The processing device 3 cuts out the image at the timing of the pointing to the coordinates from the image, and crops the rectangular region designated by the coordinates in the image (step S73). The processing device 3 annotates the cropped image by associating the classification result (step S74). The processing device 3 stores annotated images in the storage device 4 as training data related to the task object and task content (step S75).

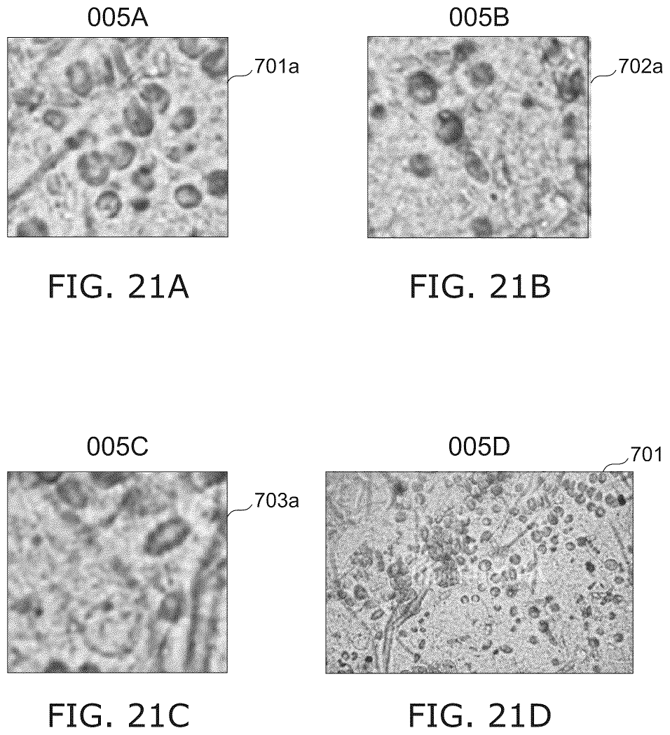

FIGS. 21A to 21D are examples of training data.

FIG. 21A is an image 701a cropped from the image 701 shown in FIG. 15. “005A” that indicates the classification of the seaweed is annotated in the image 701a. Similarly, FIGS. 21B and 21C are respectively cropped images 702a and 703a; and “005B” and “005C” that indicate the classifications are annotated.

When the worker 510 or the instructor 520 points to a coordinate, the coordinate is not recorded when the information for calculating the line of sight is insufficient, or when intention understanding cannot be appropriately performed. As a result, the classification is annotated for the entire image as shown in FIG. 21D. As in step S10 shown in FIG. 4, such inappropriate training data is corrected by the user; and the corrected training data is stored.

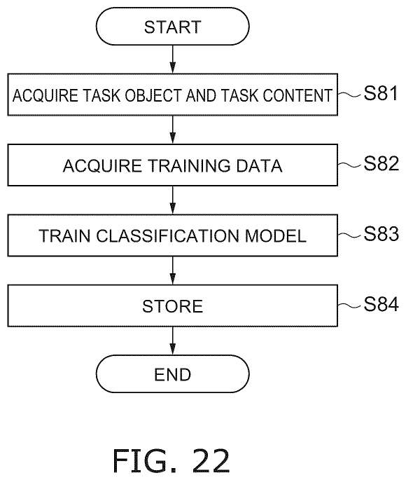

FIG. 22 is a flowchart showing processing by the training device according to the embodiment.

The training device 5 uses the training data extracted by the processing device 3 to perform training. As shown in FIG. 22, the training device 5 acquires the task object and the task content to determine a trained model (step S81). The training device 5 acquires data in which the task object and the task content are associated from the training data stored by the processing device 3 (step S82).

The training device 5 uses the acquired training data to train a classification model (step S83). The classification model outputs a classification result according to the input of the image. For example, the classification model includes a neural network. Supervised learning of the classification model is performed. In the supervised learning, images are used as input data; and the classifications are used as labels. The training device 5 stores the trained classification model (step S84).

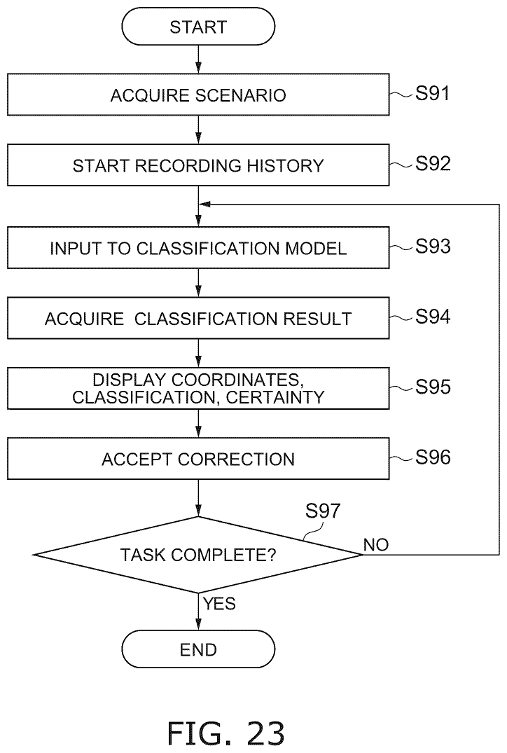

FIG. 23 is a flowchart showing processing by the processing device according to the embodiment.

After completing the training by the training device 5, the processing device 3 can use the trained classification model to instruct or support the task. After completing the training, the processing device 3 can be selected instead of the instructor in step S6 of the flowchart shown in FIG. 4.

When instruction by the processing device 3 is selected, the processing device 3 acquires a scenario corresponding to the device of the task object and the task content as shown in FIG. 23 (step S91). The processing device 3 starts recording the task history (step S92). The processing device 3 inputs the image that is imaged to the classification model (step S93), and acquires the classification result of the classification model (step S94). The processing device 3 displays, in the HMD of the worker 510, the certainty and the coordinate and classification for which the highest certainty was obtained as guidance related to the task (step S95). When the classification is inappropriate, the processing device 3 accepts a correction of the classification (step S96). The processing device 3 repeats the output of the classification result until the task is determined to be complete in step S97.

The history data is recorded also during the instruction by the processing device 3. Training data may be generated from the obtained history data. The training device 5 uses the generated training data to perform training. In such a case, a new classification model may be generated, or an existing classification model may be retrained.

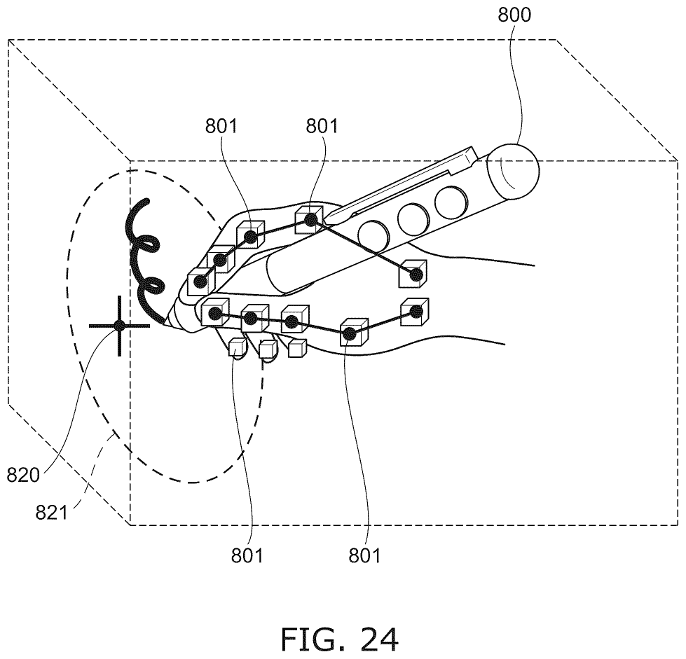

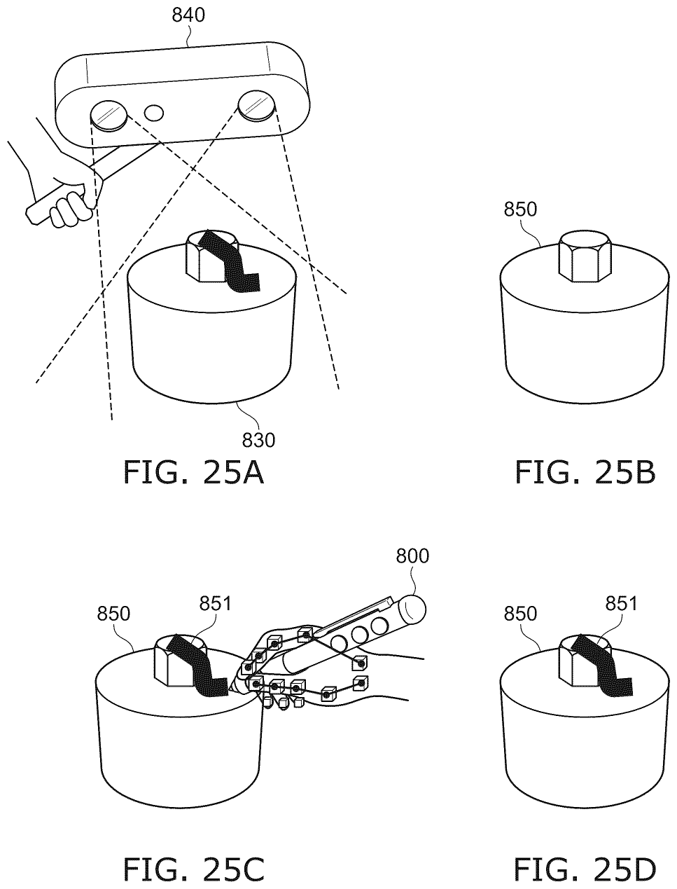

FIG. 24 and FIGS. 25A to 25D are schematic views illustrating a pointing part according to the embodiment.

A virtual pointing tool other than the eye tracking described above may be used as a pointing part. For example, the processing device 3 detects a person's hand visible in the image. In other words, the processing device 3 performs hand tracking. A pose estimation model can be used to detect the hand. The pose estimation model outputs positions of skeletal parts of the human body according to the input of the image. The pose estimation model includes a neural network. It is favorable for the pose estimation model to include a convolutional neural network (CNN). OpenPose, DarkPose, CenterNet, etc., can be used as the pose estimation model.

For example, as shown in FIG. 24, the user moves the hand of the user into the shape of holding a writing implement. The processing device 3 detects multiple joints 801 of the hand as skeletal parts. The processing device 3 displays a virtual pointing tool 800 when the positional relationship of the multiple joints 801 is determined to be the shape of a hand holding a writing implement. When the user moves the hand, the processing device 3 moves the pointing tool 800 according to the movement of the hand. A coordinate can be pointed to by the user using the pointing tool 800 to tap a part of the image while the pointing tool 800 is displayed.

The user also can draw freely with the pointing tool 800. The processing device 3 displays a drawing region 821 beyond a line of sight 820 of the user. The user can use the pointing tool 800 to depict virtual figures, characters, symbols, etc., in the drawing region 821.

The pointing tool 800 also can be used to mark virtual objects. For example, as shown in FIG. 25A, a product 830, which is the task object, is scanned by a 3D scanner 840. 3D data 850 of the product 830 is obtained as shown in FIG. 25B by multiple scans. When the worker or instructor determines that the synthesized 3D data 850 is good, a virtual mark 851 is made on the 3D data 850 with the pointing tool 800 as shown in FIG. 25C. As shown in FIG. 25D, the 3D data 850 is stored together with the mark 851.

Due to the mark 851, the user can ascertain that the quality of the 3D data 850 has already been checked, the quality of the 3D data 850 has been determined to be good, etc. The convenience of the user can be improved by displaying tools that can draw as well as point. By storing the data so that the data is associated with the content drawn by the tool, the user can easily ascertain information related to the data.

Advantages of embodiments will now be described.

It is effective for the task to show specific points (coordinates) on the image during the instruction. By the instructor specifically indicating the coordinates, the worker can easily understand the points to be given attention or the points to be worked on. Therefore, as long as the coordinates can be shown to the worker, at least a part of the instruction can be automated without being dependent on the instructor.

Many points (coordinates) are pointed to on the image in the task by the worker and during the instruction by the instructor. For example, the worker may ask a question about a specific point, or may check a location that is not directly related to the task. Therefore, only a part of the coordinates among the many coordinates obtained in the task are directly related to the task. However, it is difficult to manually extract only coordinates among the many obtained coordinates that are useful for automating the instruction.

For this problem, the processing device 3 according to the embodiment acquires, from the storage device 4, images, coordinates, and dialog data communicated between the first device 1 and the second device 2. Then, the processing device 3 extracts at least one of the coordinates from the communicated multiple coordinates based on the dialog data. By utilizing the dialog data, only the coordinates directly related to the task can be automatically extracted. The extracted coordinates can be utilized to train for automating the instruction.

According to embodiments, data that can be utilized for training can be automatically acquired, and the burden of preparing the data can be reduced.

For example, by performing intention understanding for the dialog data and by extracting coordinates according to a scenario corresponding to each task, the coordinates that are more directly related to the task can be extracted with higher accuracy.

Even more coordinates are obtained in the task when the coordinates are obtained and stored by eye tracking of the first and second devices 1 and 2. For example, the multiple first coordinates transmitted from the first device 1 to the second device 2 and the multiple second coordinates transmitted from the second device 2 to the first device 1 are obtained. According to embodiments, the coordinates that are more directly related to the task can be extracted from an enormous number of stored coordinate. For example, at least one of the multiple first coordinates directly related to the task and at least one of the multiple second coordinates directly related to the task are extracted.

Training data can be generated using the extracted coordinates. As in the example above, the pointing coordinates relative to the task object in the image are generated as the training data. Or, a region that corresponds to the pointing coordinate is cropped from the image. A classification result is associated with the cropped image, and is stored as the training data. By training with the generated training data, at least a part of the instruction can then be automated using the training result.

In the example above, HMDs are used as the first and second devices 1 and 2. The first device 1 and the second device 2 are not limited to the example, and may be devices other than HMDs. For example, a combination of a monitor, a camera, a microphone, a pointing device, and a speaker is used for each of the first device 1 and the second device. The worker and the instructor converse using the microphones and speakers. The worker images the task object with a camera. Each monitor displays the resulting images in a user interface. The worker and the instructor point to locations on the user interface to be worked on, etc., by using a pointing device.

In such a case as well, history data can be acquired as shown in FIG. 9, FIG. 19, etc. Also, training data can be generated by extracting a part of the data from the history data. The generated training data can be used to perform training.

However, it is desirable for the first device 1 and the second device 2 to be HMDs to increase the efficiency of the task and the convenience of the worker and instructor. By using HMDs, various operations such as imaging, pointing, and the like can be performed while the worker works. The instructor can share the visual field of the worker as a more realistic visual field.

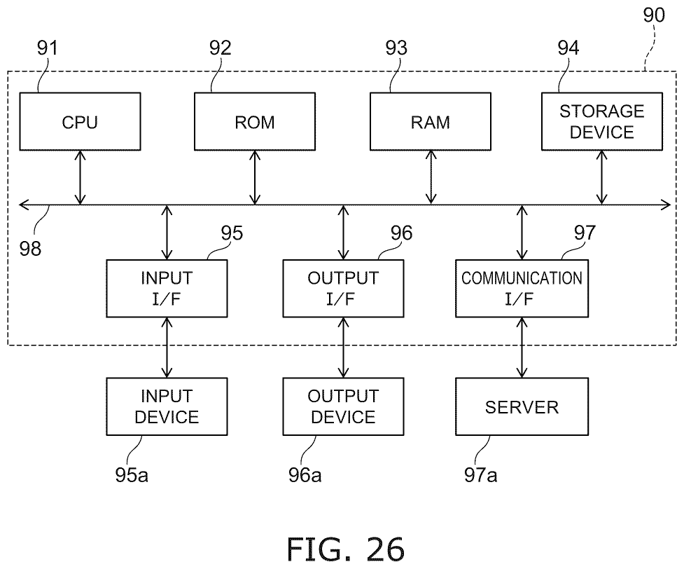

FIG. 26 is a schematic view illustrating a hardware configuration.

For example, as the processing device 3 and the training device 5, a computer 90 shown in FIG. 26 is used. The computer 90 includes a CPU 91, ROM 92, RAM 93, a memory device 94, an input interface 95, an output interface 96, and a communication interface 97.

The ROM 92 stores programs that control the operations of the computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the programs, the CPU 91 executes various processing by controlling configurations via a system bus 98. The memory device 94 stores data necessary for executing the programs and/or data obtained by executing the programs.

The input interface (I/F) 95 connects the computer 90 and an input device 95a. The input I/F 95 is, for example, a serial bus interface such as USB, etc. The CPU 91 can read various data from the input device 95a via the input I/F 95.

The output interface (I/F) 96 connects the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to output information.

The communication interface (I/F) 97 connects the computer 90 and a server 97a outside the computer 90. The communication I/F 97 is, for example, a network card such as a LAN card, etc. The CPU 91 can read various data from the server 97a via the communication I/F 97. The data of the storage device 4 may be stored in the server 97a.

The memory device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor and a projector.

The functions of the processing device 3 may be realized by one computer 90 or may be realized by the collaboration of multiple computers 90. The functions of the training device 5 may be realized by one computer 90 or may be realized by the collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

According to the embodiments described above, a processing device, a training device, a processing system, a processing method, a program, and a storage medium are provided in which data usable for training can be automatically acquired.

The embodiments may include the following features.

### (Feature 1)

A processing device, configured to:
acquire an image, a coordinate, and dialog data communicated between a first device and a second device, the first device being used by a first person performing a task, the second device being used by a second person;
extract at least one of a plurality of the coordinates based on the dialog data; and
associate the extracted at least one of the plurality of coordinates with the task.

### (Feature 2)

The processing device according to Feature 1, further configured to:
select a first scenario corresponding to the task from a plurality of scenarios,
processing procedures being defined for the plurality of scenarios,
the extracting of the part of the plurality of coordinates being based on an intention understanding for the dialog data according to the first scenario.

### (Feature 3)

The processing device according to Feature 1 or 2, wherein the plurality of coordinates includes:
a plurality of first coordinates transmitted from the first device to the second device; and
a plurality of second coordinates transmitted from the second device to the first device, and
at least one of the plurality of first coordinates and at least one of the plurality of second coordinates are extracted based on the dialog data.

### (Feature 4)

The processing device according to any one of Features 1 to 3, wherein
the first device and the second device each are head mounted displays, and
the plurality of coordinates includes a coordinate pointed to by eye tracking.

### (Feature 5)

The processing device according to any one of Features 1 to 4, further configured to:
generate training data related to the task by using the extracted at least one of the plurality of coordinates.

### (Feature 6)

The processing device according to Feature 5, wherein
a coordinate of an object of the task visible in the image is calculated, and
a relative coordinate of the extracted at least one of the plurality of coordinates with respect to the coordinate of the object is generated as the training data.

### (Feature 7)

The processing device according to Feature 5 or 6, wherein
in the generating of the training data, the image including the extracted at least one of the plurality of coordinates and a classification of the image are associated and generated as the training data.

### (Feature 8)

A training device, configured to:
perform machine learning by using the training data generated by the processing device according to any one of Features 5 to 7.

### (Feature 9)

The training device according to Feature 8, wherein the machine learning includes performing clustering or training a classification model.

### (Feature 10)

A processing device, configured to:
transmit, to the first device, guidance related to the task by using data trained by the training device according to Feature 8.

### (Feature 11)

A processing system, comprising:
a first device mounted to a first person performing a task;
a second device mounted to a second person;
a processing device configured to
   acquire an image, a coordinate, and dialog data communicated between the first device and the second device,
   extract at least one of a plurality of the coordinates based on the dialog data, and
   generate training data related to the task by using the extracted at least one of the plurality of coordinates; and
a training device performing machine learning by using the training data.

### (Feature 12)

A processing method, comprising:
acquiring an image, a coordinate, and dialog data communicated between a first device and a second device, the first device being used by a first person performing a task, the second device being used by a second person;
extracting at least one of a plurality of the coordinates based on the dialog data; and
associating the extracted at least one of the plurality of coordinates with the task.

### (Feature 13)

A program causing a computer to perform the method according to Feature 12.

### (Feature 14)

A non-transitory computer readable storage medium storing the program according to Feature 13.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions and are within the scope of the inventions described in the claims and their equivalents. The embodiments described above can be implemented in combination with each other.

What is claimed is:

1. A processing device, configured to:
acquire an image, a coordinate, and dialog data communicated between a first device and a second device, the first device being used by a first person performing a task, the second device being used by a second person;
extract at least one of a plurality of the coordinates based on the dialog data; and
associate the extracted at least one of the plurality of coordinates with the task.

2. The processing device according to claim 1, further configured to:
select a first scenario corresponding to the task from a plurality of scenarios,
processing procedures being defined for the plurality of scenarios,
the extracting of the part of the plurality of coordinates being based on an intention understanding for the dialog data according to the first scenario.

3. The processing device according to claim 1, wherein
the plurality of coordinates includes:
a plurality of first coordinates transmitted from the first device to the second device; and
a plurality of second coordinates transmitted from the second device to the first device, and
at least one of the plurality of first coordinates and at least one of the plurality of second coordinates are extracted based on the dialog data.

4. The processing device according to claim 1, wherein
the first device and the second device each are head mounted displays, and
the plurality of coordinates includes a coordinate pointed to by eye tracking.

5. The processing device according to claim 1, further configured to:
generate training data related to the task by using the extracted at least one of the plurality of coordinates.

6. The processing device according to claim 5, wherein
a coordinate of an object of the task visible in the image is calculated, and
a relative coordinate of the extracted at least one of the plurality of coordinates with respect to the coordinate of the object is generated as the training data.

7. The processing device according to claim 5, wherein
in the generating of the training data, the image including the extracted at least one of the plurality of coordinates and a classification of the image are associated and generated as the training data.

8. A training device, configured to:
perform machine learning by using the training data generated by the processing device according to claim 5.

9. The training device according to claim 8, wherein
the machine learning includes performing clustering or training a classification model.

10. A processing device, configured to:
transmit, to the first device, guidance related to the task by using data trained by the training device according to claim 8.

11. A processing system, comprising:
a first device mounted to a first person performing a task;
a second device mounted to a second person;
a processing device configured to
acquire an image, a coordinate, and dialog data communicated between the first device and the second device,
extract at least one of a plurality of the coordinates based on the dialog data, and
generate training data related to the task by using the extracted at least one of the plurality of coordinates; and
a training device performing machine learning by using the training data.

12. A processing method, comprising:
acquiring an image, a coordinate, and dialog data communicated between a first device and a second device, the first device being used by a first person performing a task, the second device being used by a second person;
extracting at least one of a plurality of the coordinates based on the dialog data; and
associating the extracted at least one of the plurality of coordinates with the task.

13. A non-transitory computer-readable storage medium storing a program,
the program, when executed by a computer, causing the computer to perform the method according to claim 12.
